(19) United States
(12) Patent Application Publication
(10) Pub. No.: US 2016/0020913 A1
(43) Pub. Date: Jan. 21, 2016

(54) METHOD FOR POWER SAVING IN OPTICAL ACCESS NETWORK BY USING SYNCHRONIZED SLEEP CYCLE

(71) Applicant: Electronics and Telecommunications Research Institute, Daejeon (KR)

(72) Inventors: Sung Chang KIM, Gwangju (KR); Geun Yong KIM, Gwangju (KR); Hee Do KIM, Seoul (KR); Hark YOO, Gwangju (KR); Dong Soo LEE, Seongnam-si (KR); Young Suk LEE, Gwangju (KP)

(73) Assignee: Electronics and Telecommunications Research Institute, Daejeon (KR)

(21) Appl. No.: 14/446,949

(22) Filed: Jul. 30, 2014

(30) Foreign Application Priority Data
Jul. 18, 2014 (KR) 10-2014-0091210

(51) Int. Cl. H04L 12/12; H04B 10/27; H04B 10/40

(52) U.S. Cl. CPC H04L 12/12; H04B 10/40; H04B 10/27

(57) ABSTRACT

Provided is a power saving method of an optical network terminal and an optical line terminal. The optical network terminal may receive a sleep synchronization message about a first sleep group from the optical line terminal, and when the optical network terminal is included in the first sleep group, may turn OFF an optical transmitter and turn ON the optical transmitter after a first sleep cycle of the first sleep group is elapsed, thereby saving power.

### CROSS-REFERENCE TO RELATED APPLICATIONS

This application claims the priority benefit of Korean Patent Application No. 10-2013-0091598, filed on Aug. 1, 2013, and Korean Patent Application No. 10-2014-0091210, filed on Jul. 18, 2014, in the Korean Intellectual Property Office, the disclosures of which are incorporated herein by reference.

### BACKGROUND

1. Field of the Invention

Embodiments of the following description relate to a power saving method of an optical network terminal (ONT) and an optical line network (OLT), and more particularly, to a power saving method of an ONT and an OLT using a synchronized sleep cycle.

2. Description of the Related Art

Currently, the International Telecommunications Union-Telecommunication (ITU-T) has recognized the importance in saving power in a next generation optical subscriber network and thus, has actively conducted research on a power management method of an optical network terminal (ONT). A dozing sleep mode and a cyclic sleep mode are known as the power management method of the ONT.

In the dozing sleep mode, only an optical transmitter of the ONT may be periodically turned ON or OFF in a state in which an optical receiver of the ONT is turned ON at all times. In the dozing sleep mode, a relatively low power saving efficiency may be achieved, however, a stable operation is enabled.

In the cyclic sleep mode, both the optical transmitter and the optical receiver of the ONT may be periodically turned ON or OFF. In the cyclic sleep mode, a relatively high power saving efficiency may be achieved, however, a further complex control method may be required to achieve an accurate operation.

### SUMMARY

According to an aspect, there is provided a power saving method of an optical network terminal (ONT), the method including: receiving a sleep synchronization message about a first sleep group from an optical line terminal (OLT); and shifting to an asleep state for turning OFF an optical transmitter when the ONT is included in the first sleep group.

The power saving method of the ONT may further include shifting to a sleep aware state for turning ON the optical transmitter after a first sleep cycle of the first sleep group is elapsed.

An optical receiver may be further turned OFF in the asleep state, and the optical receiver may be further turned ON in the sleep aware state.

The power saving method of the ONT may further include maintaining a sleep aware state in which the optical transmitter is turned ON when the ONT is not included in the first sleep group.

The ONT may be grouped into one of at least one sleep group through signaling with the OLT.

A sleep cycle of each of the at least one sleep group may be differently set. Also, the sleep cycle of each of the at least one sleep group may be differently set based on a type of a service provided from an ONT included in each of the at least one sleep group and a hardware performance of the ONT.

The power saving method of the ONT may further include shifting from a sleep aware state to an active-held state for performing a normal operation when the ONT receives a low power state end request message from the OLT.

The shifting to the active-held state may include transmitting a low power state switch end message to the OLT when the ONT shifts from the sleep aware state to the active-held state.

According to another aspect, there is provided a power saving method of an OLT, the method including: grouping at least one ONT into at least one sleep group; and transmitting a sleep synchronization message about the at least one sleep group to the at least one ONT.

The grouping may include differently setting a sleep cycle of each of the at least one sleep group.

The differently setting may include differently setting the sleep cycle of each of the at least one sleep group based on a type of a service provided from an ONT included in each of the at least one sleep group and a hardware performance of the ONT.

The transmitting may include transmitting the sleep synchronization message to an ONT included in each of the at least one sleep group, at a sleep cycle corresponding to each of the at least one sleep group.

The power saving method of the OLT may further include: shifting from a low power sleep state to an alerted sleep state when data to be transmitted to a first ONT is received; and removing the first ONT from a sleep group including the first ONT.

The shifting to the alerted sleep state may include transmitting a low power state end request message to the first ONT.

The power saving method of the OLT may further include shifting from the alerted sleep state to an awake forced state for performing a normal operation in response to a low power state switch end message received from the first ONT.

The grouping may include grouping the ONT into one of at least one sleep group through signaling with the ONT.

The power saving method of the OLT may further include: transmitting a low power state start request message to a second ONT when traffic about the second ONT is absent during a predetermined duration of time; and shifting from an awake forced state for performing a normal operation to a low power sleep state for power saving.

The shifting to the low power sleep state may include adding the second ONT to a sleep group determined to include the second optical network.

According to still another aspect, there is provided a power saving method of an ONT, the method including: receiving a sleep synchronization message about a predetermined first sleep group from an OLT; and determining whether to communicate with the OLT, depending on whether the ONT is included in the first sleep group.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a relationship between an optical line terminal (OLT) and an optical network terminal (ONT) according to the related art.

FIG. 2 illustrates an operation flow and an operation state of a cyclic sleep mode according to the related art.

FIG. 3 illustrates a relationship between an OLT and an ONT according to an embodiment.

FIG. 4 illustrates an operation flow and an operation state of a power saving method using a synchronized sleep cycle according to an embodiment.

FIG. 5 illustrates the entire flow of a power saving method using a synchronized sleep cycle according to an embodiment.

FIG. 6 is a block diagram illustrating an ONT according to an embodiment.

FIG. 7 is a block diagram illustrating an OLT according to an embodiment.

FIG. 8 is a flowchart illustrating a power saving method of an ONT according to an embodiment.

FIG. 9 is a flowchart illustrating a power saving method of an OLT according to an embodiment.

### DETAILED DESCRIPTION

Reference will now be made in detail to embodiments, examples of which are illustrated in the accompanying drawings, wherein like reference numerals refer to like elements throughout. Embodiments are described below to explain the present invention by referring to the figures.

Terms used in the following are generally and widely used in the art, however, other terms may also be used based on the development and/or change of technology, custom, and preference of those skilled in the art. Accordingly, terms used in the following description should not be understood to be limiting the technical spirit and should be understood as exemplary terms to explain the embodiments.

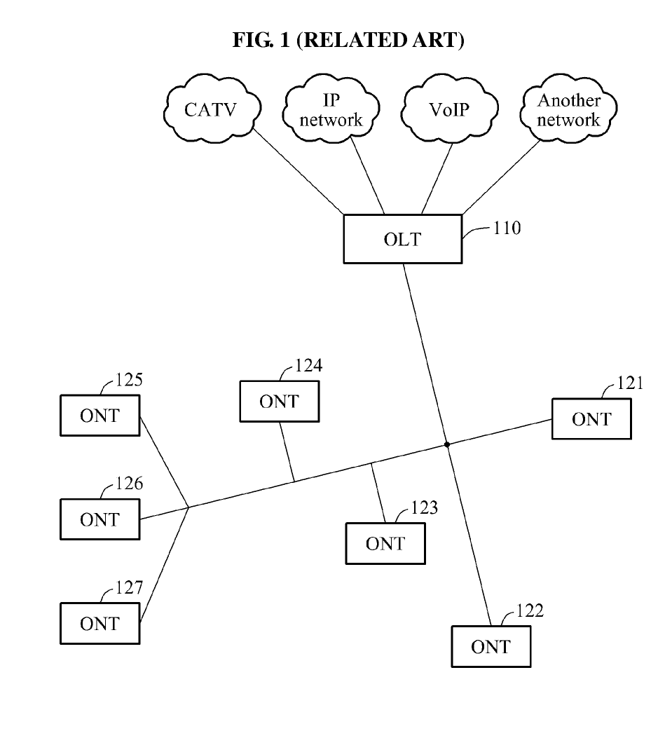

FIG. 1 illustrates a relationship between an optical line terminal (OLT) 110 and optical network terminals (ONT) 121, 122, 123, 124, 125, 126, and 127 according to the related art.

The OLT 110 refers to a portion of an optical subscriber network and to a terminal of a service provider side. The OLT 110 refers to a multi-service device that connects the optical subscriber network to another system. For example, the OLT 110 may connect the optical subscriber network to a cable television (CATV), an Internet protocol (IP) network, a voice over Internet protocol (VoIP), or another network.

Each of the ONTs 121, 122, 123, 124, 125, 126, and 127 refers to a terminal to connect to an optical subscriber system that constitutes a next generation communication network. Each of the ONTs 121, 122, 123, 124, 125, 126, and 127 refers to an optical terminal of a service subscriber side and may be connected to the OLT 110 through an optical fiber and the like.

In terms of power consumption in a network field, an amount of power consumed by a subscriber network occupies most of the entire network power consumption amount. Here, the entire power consumption amount of the ONTs 121, 122, 123, 124, 125, 126, and 127 distributed to the respective homes may occupy a large ratio of the entire power consumption amount.

The importance in saving power in the next generation optical subscriber network has been recognized as above and in this regard, a dozing sleep mode and a cyclic sleep mode have been discussed as standards. However, as described above, in the dozing sleep mode, a stable operation is enabled, however, a relatively low power saving efficiency may be achieved. In the cyclic sleep mode, a relatively high power saving efficiency may be achieved, however, a further complex control method may be required to achieve an accurate operation.

Also, in the cyclic sleep mode, although hardware is configured to be complex, an unpredicted processing delay and deviation may occur. To compensate for the processing delay and the deviation, an ONT may need to set T_{Aware} to be relatively great.

Hereinafter, the aforementioned issues will be further described by describing an operation and an operation state of the cyclic sleep mode.

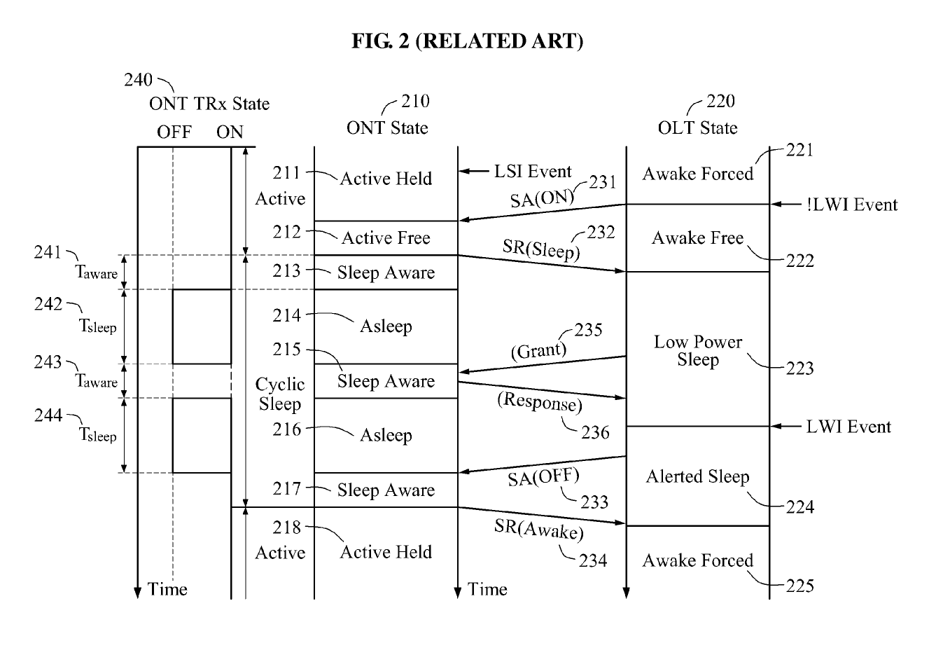

FIG. 2 illustrates an operation flow and an operation state of a cyclic sleep mode according to the related art.

FIG. 2 illustrates an operation in a case in which an ONT operates in a cyclic sleep mode, a state 210 of an ONT, a state 220 of an OLT, and a state 240 of an optical transmitter/receiver.

In a normal operation state in which data transmission and reception is normally performed, not in a power saving state, the ONT may operate in an active held state 211. Here, the normal operation state in which data transmission and reception is normally performed may refer to a state in which the optical receiver and the optical transmitter of the ONT are continuously turned ON instead of being periodically turned ON or OFF.

When traffic is absent during a predetermined duration of time, a location sleep indication (LSI) event may occur and the OLT may wait for a low power state start request message (sleep allow (SA) (ON)) 231 from the OLT.

When a first ONT normally operates, the OLT may operate in an awake forced state 221 with respect to the first ONT.

Also, when traffic to be transmitted to and received from the first ONT is absent during a predetermined duration of time, the OLT may trigger a !local wake-up indication (!LWI) event and may immediately transmit the low power state start request message (SA (ON)) 231 to the first ONT. Next, the OLT may shift to an awake free state 222 that is one of low power states of the OLT.

In response to the low power state start request message (SA (ON)) 231 received from the OLT, the first ONT may shift to an active free state 212 that is one of low power states of the ONT. Also, in response to the low power state start request message (SA (ON)) 231, the ONT may transmit a low power state switch message (sleep request (SR) (sleep)) 232 to the OLT. Next, a cyclic sleep mode in which the first ONT repeatedly switches between asleep aware states 213, 215, and 217, and asleep states 214 and 216.

In response to the low power state switch message (SR (sleep)) 232, the OLT may shift from the awake free state 222 to a low power sleep state 223. As long as the first ONT maintains the cyclic sleep mode, the OLT may maintain the low power sleep state 223.

During a duration of time in which the sleep aware states 213, 215, and 217 are maintained in the cyclic sleep mode, that is, during T_{aware} 241 and 243, the first ONT may turn ON the optical transmitter/receiver. On the other hand, during a duration of time in which asleep states 214 and 216 are maintained, that is, during Tₛₗₑₑₚ 242 and 244, the first ONT may turn OFF the optical transmitter/receiver.

In operation 235, the OLT may grant a band so that the first ONT may receive data in the sleep aware state. Also, in operation 236, the first ONT may respond to the granted band and may inform that the first ONT normally operates in the cyclic sleep mode.

When the OLT receives data to be transmitted to the first ON while the cyclic sleep mode continues, an LWI event may occur in the OLT and the OLT may shift to an alerted sleep state 224.

In time for the sleep aware state 217 of the first ONT, the OLT may transmit a low power state end request message (SA (OFF)) 233 requesting suspension of the cyclic sleep mode.

In response to the low power state end request message (SA (OFF)) 233, the first ONT may transmit a low power state switch end message (SR (Awake)) 234 to the OLT and may shift to the active held state 218. In response to the received low power state switch end message (SR (Awake)) 234, the OLT may shift to an awake forced state 225 and may perform a normal operation.

Although the description is made above based on the cyclic sleep mode, the dozing sleep mode also enables the same operation as in the cyclic sleep mode excluding that the optical receiver is turned ON in an asleep state. Accordingly, a description related to the dozing sleep mode will be omitted.

In the power saving method using the cyclic sleep mode, the respective ONTs may asynchronously operate with respect to each other in the cyclic sleep mode. That is, ON/OFF operation time of an optical transmitter/receiver may differ for each of the ONTs that operate in the cyclic sleep mode.

Accordingly, the OLT may need to be accurately aware of ON/OFF times of optical transmitters/receivers of ONTs that operate in the cyclic sleep mode. Also, the OLT may need to accurately transfer a message to fit for an ON-time.

However, the above operation requirements, for example, requesting the OLT to transfer a message to fit for a sleep aware time of the ONT may require a very complex hardware configuration.

Accordingly, the power saving method using the existing cyclic sleep mode may increase the hardware complexity of the OLT due to an asynchronous sleep cycle management between the OLT and the ONT. Also, due to an unpredicted processing delay, a jitter, and a transmission delay of the OLT and the ONT, a compensation issue for T_{aware} that requires setting T_{aware} to be sufficiently great may arise.

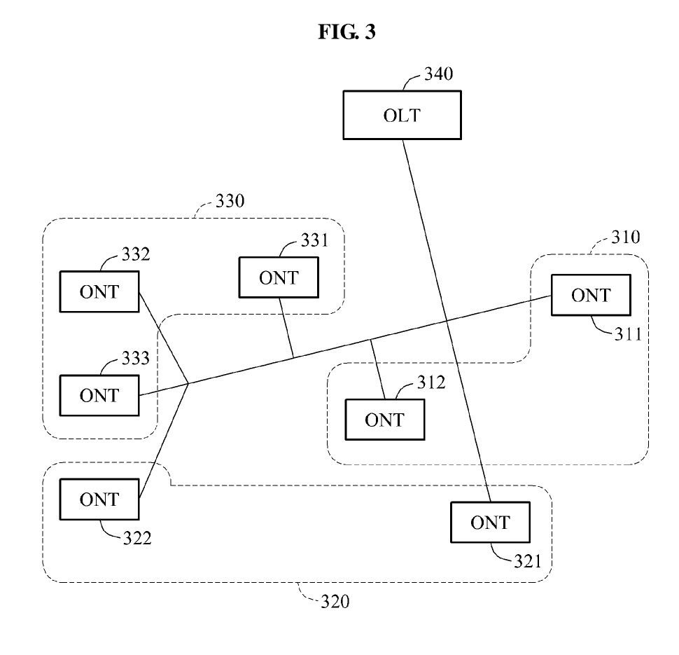

FIG. 3 illustrates a relationship between an OLT 340 and ONTs 310, 311, 312, 321, 322, 331, 332, and 333 according to an embodiment.

Referring to FIG. 3, the ONTs 311, 312, 321, 322, 331, 332, and 333 are grouped into three groups by the OLT 340 for a synchronous sleep cycle management.

The OLT 340 may also transmit the same sleep synchronization message (sleep allow (SA)) to all the ONTs communicating with the OLT 340. Here, transmitting a sleep synchronization message at a different cycle into consideration of an end of a service being provided from each ONT and a hardware performance of each ONT may be more efficient in saving power.

In FIG. 3, the ONTs 310, 311, 312, 321, 322, 331, 332, and 333 are grouped into a first sleep group 310, a second sleep group 320, and a third sleep group 330 by the OLT 340. Each sleep group may have a different sleep cycle. Here, the sleep cycle may refer to a time in which all of an optical transmitter and an optical receiver are turned OFF in a cyclic sleep mode and a time in which the optical transmitter is turned OFF in a dozing sleep mode.

The sleep cycle of each sleep group may be differently set based on a type of a service provided from an ONT included in each sleep group and a hardware performance of the ONT.

For example, in the case of an ONT that provides an Internet call service such as a VoIP service, an event for receiving a call from an OLT may occur. Accordingly, a sleep cycle of the ONT cannot be set to be long and thus, the ONT that provides the Internet call service may be allowed to join a sleep group having a relatively short sleep cycle (Tₛₗₑₑₚ_{_{—}}ᵢ).

On the other hand, a sleep cycle of an ONT that provides only a simple data service may be set to be relatively long. Accordingly, the ONT that provides only a simple data service may be allowed to join a sleep group having a relatively long sleep cycle.

As another example, hardware specification of an optical transmitter/receiver and an electronic circuit used by each ONT may be different. For example, a first ONT may have hardware specification capable of supporting a relatively short sleep cycle and a second ONT may not support the relatively short sleep cycle due to low hardware specification. To shift from an asleep state to a sleep aware state, the second ONT may require a relatively long duration of time compared to the first ONT. Accordingly, the OLT may make a decision so that the ONT may be included in a sleep group having an appropriate sleep cycle based on the hardware specification of the ONT.

As described above, a first sleep cycle (Tₛₗₑₑₚ_{_{—}}₁) of the first sleep group 310, a second sleep cycle (Tₛₗₑₑₚ_{_{—}}₂) of the second sleep group 320, and a third sleep cycle (Tₛₗₑₑₚ_{_{—}}₃) of the third sleep group 330 may differ from one another.

ONTs may be grouped into one of at least one sleep group through signaling with the OLT 340. The OLT 340 may perform grouping so that a corresponding ONT may be included in a sleep group having an appropriate sleep cycle through signaling based on a type of a service being provided from the ONT and hardware specification of the ONT.

According to an embodiment, signaling may be performed during a process in which an OLT initially brings up an ONT. In detail, during a process in which data is transmitted and received between the ONT and the OLT through ONT management control interface (OMCI) signaling, a sleep group in which the ONT is to be included may be determined That is, signaling may be performed in an operation in which the ONT is initially powered ON and the OLT discovers the ONT and enables a communication service.

As described above, when an ONT shifts to a sleep synchronization state for power saving through signaling with the OLT 340, a corresponding sleep group to include the ONT may be determined The OLT 340 may manage members of the determined sleep group, and may transmit a sleep synchronization message to the members using a multicast method. Also, the OLT 340 may transmit the sleep synchronization message based on a sleep cycle of each sleep group. Accordingly, sleep cycles of ONTs belonging to the same sleep cycle may be synchronized.

Also, although ONTs belong to different sleep groups, sleep cycles may overlap and thus, the sleep synchronization message may be simultaneously transmitted to the different sleep groups. Even in this case, the sleep cycles of the sleep groups to which the sleep synchronization message is to be simultaneously transmitted may be synchronized.

Hereinafter, a power saving method using a synchronized sleep cycle according to an embodiment will be further described.

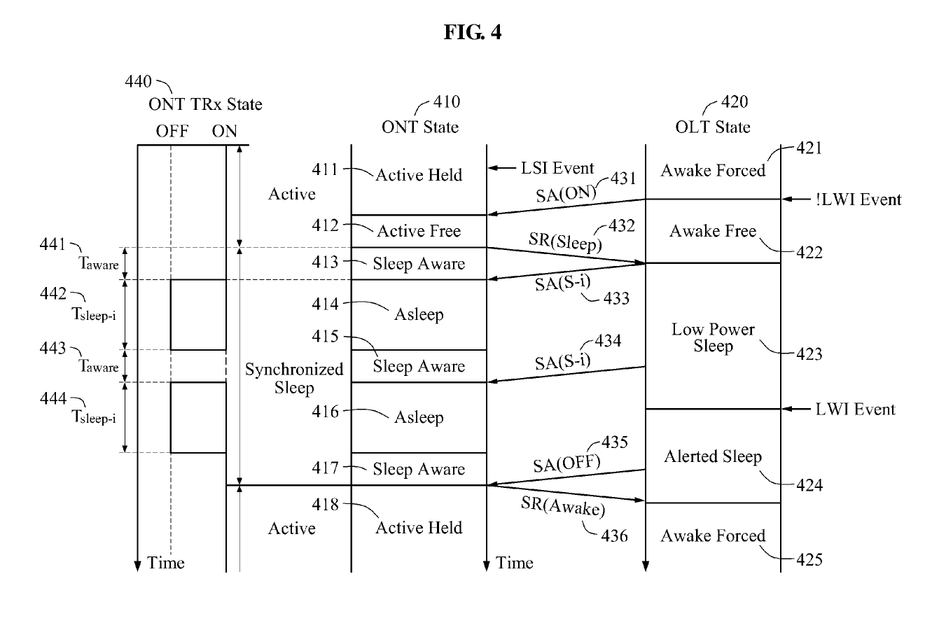

FIG. 4 illustrates an operation flow and an operation state of a power saving method using a synchronized sleep cycle according to an embodiment.

FIG. 4 illustrates a state 410 of an ONT, a state 420 of an OLT, and a state 440 of an optical transmitter/receiver of an ONT.

In a normal operation state in which data transmission and reception is normally performed, not in a power saving state, the ONT may operate in an active held state 411. Here, the normal operation state in which data transmission and reception is normally performed may refer to a state in which the optical transmitter and the optical receiver of the ONT are continuously turned ON, instead of being periodically turned ON or OFF for power saving.

When traffic is absent during a predetermined duration of time, an LSI event may occur and the ONT may wait for a low power state start request message (SA (ON)) 431 from the OLT.

When a first ONT normally operates, the OLT may operate in an awake forced state 421 with respect to the first ONT.

Also, when traffic to be transmitted to and received from the first ONT is absent during a predetermined duration of time, the OLT may trigger !LWI event and may immediately transmit the low power state start request message (SA (ON)) 431 to the first ONT. After transmitting the low power state start request message (SA (ON)) 431 to the first ONT, the OLT may allow the first ONT to join a predetermined sleep group through signaling. Next, the OLT may shift to an awake free state 422.

In response to the low power state start request message (SA (ON)) 431 received from the OLT, the first ONT may shift to an active free state 412. Also, in response to the low power state start request message (SA (ON)) 431, the first ONT may transmit a low power state switch message (SR (Sleep)) 432 to the OLT and may shift to a sleep aware state 413.

In response to the received low power state switch message (SR (Sleep)) 432, the OLT may shift from the awake free state 422 to a low power sleep state 423. As long as the first ONT maintains a synchronized sleep mode, the OLT may maintain the low power sleep state 423.

Similar to a cyclic sleep mode, even in a synchronized sleep mode, the first ONT may turn ON the optical transmitter/receiver during a duration of time in which the sleep aware states 413, 415, and 417 are maintained, that is, during T_{aware} 441 and 443. On the other hand, during a duration of time in which asleep states 414 and 416 are maintained, that is, during Tₛₗₑₑₚ_{_{—}}ᵢ 442 and 444, the first ONT may turn OFF the optical transmitter/receiver.

The OLT may periodically transmit a sleep synchronization message (SA (S_i)) 433 or 434 to the ONT using a multicast method. Here, S_i denotes an i-th sleep group, and a sleep synchronization message (SA (S_i)) may be transmitted at a cycle of Tₛₗₑₑₚ_{_{—}}ᵢ. That is, the OLT may transmit the sleep synchronization message (SA (S_i)) to an ONT included in each sleep group at a sleep cycle of each sleep group.

In response to the received sleep synchronization message (SA (S_i)), the first ONT may shift from the sleep aware state 413 to the asleep state 414. The asleep state 414 of the first ONT may continue during Tₛₗₑₑₚ_{_{—}}ᵢ. That is, a duration of time in which an asleep state of the first ONT continues corresponds to a sleep cycle of a sleep group that includes the first ONT.

The ONT may shift from the asleep state 414 to the sleep aware state 415 after Tₛₗₑₑₚ_{_{—}}ᵢ is elapsed. When the ONT having shifted to the sleep aware state 415 receives the sleep synchronization message (SA (S_i)) 434 from the OLT, the ONT may shift to the asleep state 416 again. Also, the ONT may shift from the asleep state 416 to the sleep aware state 417 after Tₛₗₑₑₚ_{_{—}}ᵢ is elapsed.

When the OLT receives data to be transmitted to the first ONT while a synchronized sleep mode continues, an LWI event may occur in the OLT and the OLT may shift to an alerted sleep state 424.

In time for the sleep aware state 417 of the first ONT, the OLT may transmit a low power state end request message (SA (OFF)) 435 requesting suspension of the cyclic sleep mode.

In response to the received low power state end request message (SA (OFF)) 435, the first ONT may shift from the sleep aware state 417 to an active held state 418 for a normal operation and thus, may perform a normal data transmission and reception. Also, the OLT may remove the first ONT from the sleep group including the first ONT.

In addition, in response to the low power state end request message (SA (OFF)) 435, the first ONT may transmit a low power state switch end message (SR (Awake)) 436 to the OLT. In response to the low power state switch end message (SR (Awake)) 436, the OLT may shift to an awake forced state 425 and may perform a normal operation.

For ease of description, it is described above that all of the optical transmitter and the optical receiver of the ONT are turned OFF as in the cyclic sleep mode. However, although only the optical transmitter is turned OFF as in a dozing sleep mode, the remaining operation may be the same except for that the optical receiver is in an ON-state.

As described above, the power saving method of the ONT and the OLT according to an embodiment may minimize standby power by switching to a synchronized sleep mode corresponding to a low power mode through signaling with the OLT when transmission traffic of the ONT is absent during a predetermined duration of time.

Also, the OLT may synchronize, for each sleep group, sleep cycles of ONTs present in a synchronized sleep mode corresponding to a low power mode by periodically transmitting a sleep synchronization message for each sleep group using a multicast method.

Through this, the power saving method of the ONT and the OLT according to an embodiment may decrease the hardware complexity of the OLT by managing the synchronized sleep cycle. Also, the power saving method may minimize T_{aware} by solving the compensation issue of T_{aware} occurring due to unpredictable delay and thereby may maximize the power saving efficiency of the ONT.

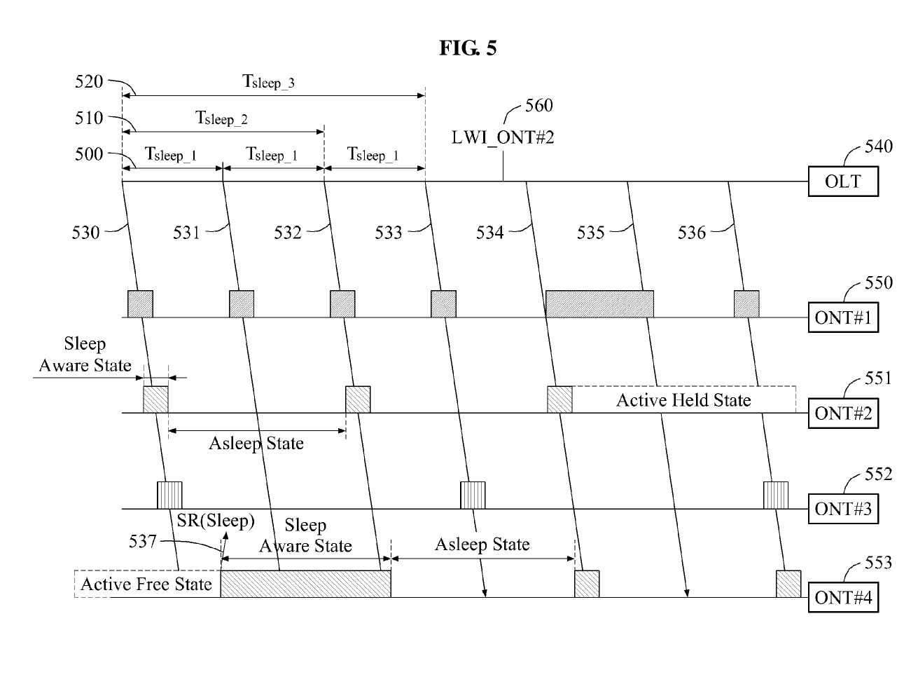

FIG. 5 illustrates the entire flow of a power saving method using a synchronized sleep cycle according to an embodiment.

Referring to FIG. 5, three sleep groups are present. A first sleep group 500 has a sleep cycle of Tₛₗₑₑₚ_{_{—}}₁, a second sleep group 510 has a sleep cycle of Tₛₗₑₑₚ_{_{—}}₂, and a third sleep group 520 has a sleep cycle of Tₛₗₑₑₚ_{_{—}}₃.

Although each sleep cycle may be arbitrarily determined, description will be made based on an example in which Tₛₗₑₑₚ_{_{—}}₂ is double of Tₛₗₑₑₚ_{_{—}}₁ and Tₛₗₑₑₚ_{_{—}}₃ is triple of Tₛₗₑₑₚ_{_{—}}₁. Also, a first ONT 550 is included in the first sleep group 500, a second ONT 551 and a fourth ONT 553 are included in the second sleep group 510, and a third ONT 552 is included in the third sleep group 520.

SA (S_1), SA (S_2), and SA (S_3) messages may be included in a data frame 530 and thereby simultaneously transmitted. Here, the SA (S_1) message refers to a sleep synchronization message for the first sleep group 500, the SA (S_2) refers to a sleep synchronization message for the second sleep group 510, and the SA (S_3) message refers to a sleep synchronization message for the third sleep group 520. The first ONT 550 may receive the SA (S_1) message in a sleep aware state and then immediately shift to an asleep state and set a timer of T_{sleep 1}. The second ONT 551 may receive the SA (S_2) message in the sleep aware state and then immediate shift to the asleep state and set a timer of Tₛₗₑₑₚ_{_{—}}₂. The third ONT 552 may receive the SA (S_3) message in the sleep aware state and then immediately shift to the asleep state and set a timer of T_{sleep 3}. The fourth ONT 533 is currently in an active free state and thus, the received SA (S_2) message may not affect a state change.

Only the SA (S_1) message may be included in a data frame 531 and thereby transmitted and thus, a state change may be significant only with respect to the first ONT 550 included in the first sleep group 500. The first ONT 550 may shift to the sleep aware state immediately after the timer of Tₛₗₑₑₚ_{_{—}}₁ is terminated. When the SA (S_1) message is received later, the first ONT 550 may immediately shift to the asleep state and then set the timer of Tₛₗₑₑₚ_{_{—}}₁ again.

Since the corresponding timers are not terminated, the second ONT 551 and the third ONT 552 still operate in the asleep state and an optical transmitter and an optical receiver are turned OFF. The fourth ONT 533 may transmit an SR (Sleep) message 537 to the OLT in the active free state and then shift to the sleep aware state. In this case, the fourth ONT 533 may receive the SA (S_1) message in the sleep aware state. The fourth ONT 533 is included in the second sleep group 510 and thus, may ignore the SA (S_1) message.

The SA (S_1) message and the SA (S_2) message may be included in a data frame 532 and thereby transmitted and thus, a sleep synchronization function may be performed on ONTs included in the first sleep group 500 and the second sleep group 510. The first ONT 550 is included in the first sleep group 500 and thus, may shift to the asleep state immediately after receiving the SA (S_1) message in the sleep aware state.

The second ONT 551 is included in the second sleep group 510 and thus, may shift to the sleep aware state immediately after the timer of Tₛₗₑₑₚ_{_{—}}₂ is terminated, in order to receive the SA (S_2) message. Once the SA (S_2) message is received, the second ONT 551 may immediately shift to the asleep state and may reset the timer of T_{sleep 2}.

The third ONT 552 is included in the third sleep group 520 and thus, is continuously maintained in the asleep state and all of the optical transmitter and the optical receiver are in an OFF-state. The fourth ONT 553 is included in the second sleep group 510. Accordingly, once the SA (S_2) message is received in the sleep aware state, the fourth ONT 553 may immediately shift to the asleep state and may set the timer of Tₛₗₑₑₚ_{_{—}}₂.

The SA (S_1) message and the SA (S_3) message may be included in a data frame 533 and thereby transmitted and thus, a sleep synchronization function may be performed on ONTs included in the first sleep group 500 and the third sleep group 520. Accordingly, a sleep cycle of the first ONT 550 included in the first sleep group 500 and a sleep cycle of the third ONT 552 included in the third sleep group 520 may be synchronized.

When an LWI request event 560 for the second ONT 551 occurs, the OLT may prepare to transmit a SA (OFF) message to wake up the second ONT 551. The OLT may include the SA (OFF) message within a data frame 534 and may transmit the SA (OFF) message to the second ONT 551 using a unicast method.

Accordingly, the SA (S_1) message and the SA (S_2) message may be included in the data frame 534 and thereby transmitted to the second OLT 551 using a multicast method, and the SA (OFF) message may be included in the data frame 534 and thereby transmitted to the second OLT 551 using a unicast method.

The first ONT 550 may exceptively operate with respect to the SA (S_1) message. Once the timer of Tₛₗₑₑₚ_{_{—}}₁ is terminated, the optical transmitter and the optical receiver of the first ONT 550 may need to be immediately turned ON and stand by in the sleep aware state. However, due to an error of the timer of Tₛₗₑₑₚ_{_{—}}₁ or a malfunction in terms of software or hardware, the optical transmitter and the optical receiver may be relatively late turned ON and thereby shift to the sleep aware state. In this case, the first ONT 550 may not receive the SA (S_1) message. Accordingly, the sleep aware state may continue until the first ONT 550 receives the SA (S_1) message included in a data frame 535. When the SA (S_1) message within the data frame 535 is received, the first ONT 550 may finally shift to the asleep state.

Once the SA (OFF) message is received, the second ONT 552 may immediately shift to an active held state to terminate a synchronized sleep mode and operate in a normal mode.

SA (S_1), SA (S_2), and SA (S_3) messages may be included in a data frame 536 and thereby simultaneously transmitted. The first ONT 550 may receive the SA (S_1) message in the sleep aware state and then immediately shift to the asleep state and set the timer of Tₛₗₑₑₚ_{_{—}}₁. The third ONT 552 may receive the SA (S_3) message in the sleep aware state and then immediately shift to the asleep state and set the timer of Tₛₗₑₑₚ_{_{—}}₃. The fourth ONT 553 may receive the SA (S_2) message in the sleep aware state and then immediately shift to the asleep state and set the timer of Tₛₗₑₑₚ_{_{—}}₂. The second ONT 551 is in the active held state and thus, the received SA (S_2) message may not affect a state change.

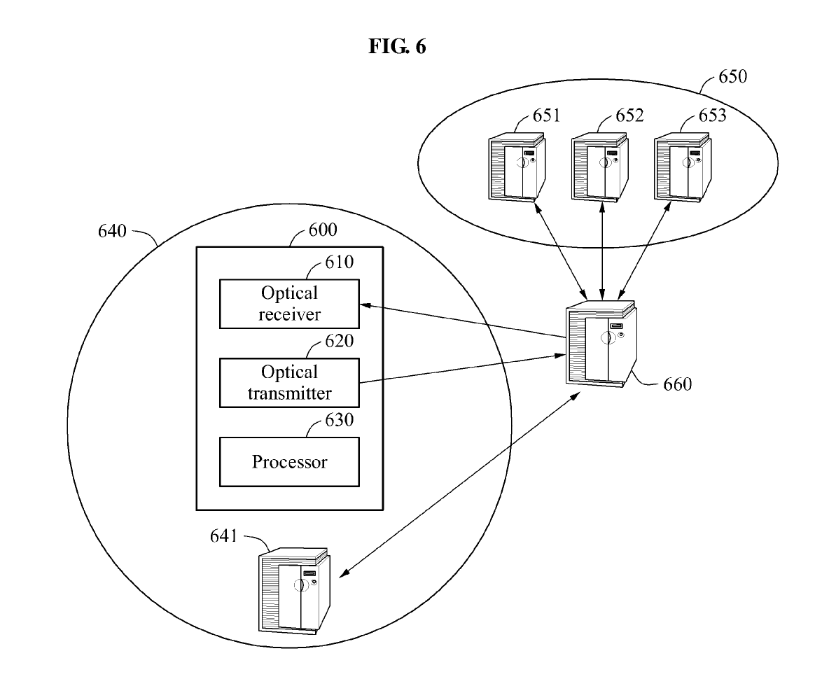

FIG. 6 is a block diagram illustrating an ONT 600 according to an embodiment.

Referring to FIG. 6, the ONT 600 may include an optical receiver 610, an optical transmitter 620, and a processor 630. The optical receiver 610 may receive data from an OLT 660, and the optical transmitter 620 may transmit data to the OLT 660.

ONTs may be grouped into at least one sleep group through signaling with the OLT 660. Referring to FIG. 6, ONTs 600 and 641 may be grouped into a first sleep group 640, and ONTs 651, 652, and 653 may be grouped into a second sleep group 650. A description related to the grouping method of ONTs is described above with reference to FIG. 3 and thus, a further detailed description will be omitted here.

For power saving, in a synchronized sleep mode, the optical receiver 610 and the optical transmitter 620 may be turned OFF in an asleep state and may be turned ON in a sleep aware state. Also, in a dozing sleep mode, the optical receiver 610 may be turned ON at all times and the optical transmitter 620 may be turned OFF in the asleep state and then be turned ON in the sleep aware state.

The processor 630 may control the optical receiver 610 and the optical transmitter 620 to be turned ON or OFF in response to a sleep synchronization message received from the OLT 660. The processor 630 may control the ONT 600 to be grouped into one of at least one sleep group through signaling with the OLT 660.

The processor 630 may determine whether the received sleep synchronization message is a sleep synchronization message for the first sleep group 640 including the ONT 600. When the received sleep synchronization message is the sleep synchronization message for the first sleep group 640, the processor 630 may turn OFF the optical receiver 610 and the optical transmitter 620.

On the contrary, when the received sleep synchronization message is not the sleep message for the first sleep group 640, the processor 630 may continuously maintain the ON-state of the optical receiver 610 and the optical transmitter 620.

The processor 630 may control a state shift of the ONT 600. For example, in response to a low power state end request message received from the OLT 660, the processor 630 may shift the ONT 600 from the sleep aware state to an active held state for performing a normal operation.

In addition, in response to a sleep synchronization message for the first sleep group 640 received from the OLT 660, the processor 630 may shift the ONT 600 to the asleep state for turning OFF the optical transmitter 620.

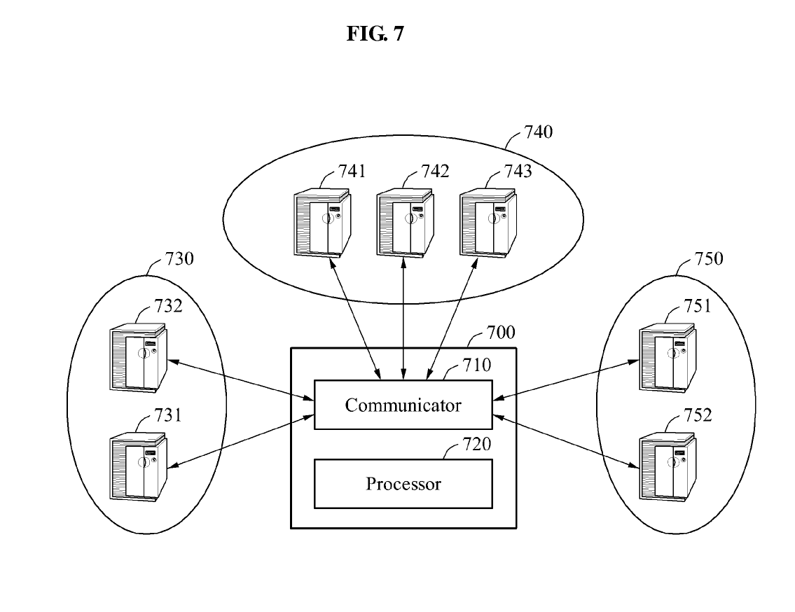

FIG. 7 is a block diagram illustrating an OLT 700 according to an embodiment.

Referring to FIG. 7, the OLT 700 may include a communicator 710 and a processor 720. The communicator 710 may transmit and receive data to and from ONTs.

The processor 720 may group at least one ONT into at least one sleep group. Also, the processor 720 may differently set a sleep cycle of each of the at least one sleep group during a grouping process.

The sleep cycle of each of the at least one sleep group may be differently set based on a type of a service being provided from an ONT included in each sleep group and a hardware performance of the ONT.

For example, the processor 720 may group ONTs 731, 732, 741, 742, 743, 751, and 752 into a first sleep group 730, a second sleep group 740, and a third sleep group 750 through signaling therewith over the communicator 710. The ONTs 731 and 732 may be included in the first sleep group 730, the ONTs 741, 742, and 743 may be included in the second sleep group 740, and the ONTs 751 and 752 may be included in the third sleep group 750.

A sleep cycle of each of the first sleep group 730, the second sleep group 740, and the third sleep group 750 may be differently set. The processor 720 may differently set a the sleep cycle based on a type of a service provided from a corresponding ONT included in each sleep group and a hardware performance of the ONT through signaling with the ONT over the communicator 710.

The processor 720 may transmit a sleep synchronization message for each sleep group through the communicator 710 at a sleep cycle of each sleep group using a multicast method. The processor 720 may control an ONT to shift from a sleep aware state to an asleep state using the sleep synchronization message.

When traffic is absent in a predetermined ONT during a predetermined duration of time, the processor 720 may transmit a low power state start request message to the predetermined ONT. Also, when traffic to be transmitted to the predetermined ONT is received, the processor 720 may remove the predetermined ONT from a sleep group including the predetermined ONT. In addition, the processor 720 may induce the predetermined ONT to operate in a normal mode by transmitting the low power state end request message to the predetermined ONT.

Also, the processor 720 may control a shift state of the OLT 700. For example, when data to be transmitted to the predetermined ONT is received, the processor 700 may shift the OLT 700 from a low power sleep state to an alerted sleep state.

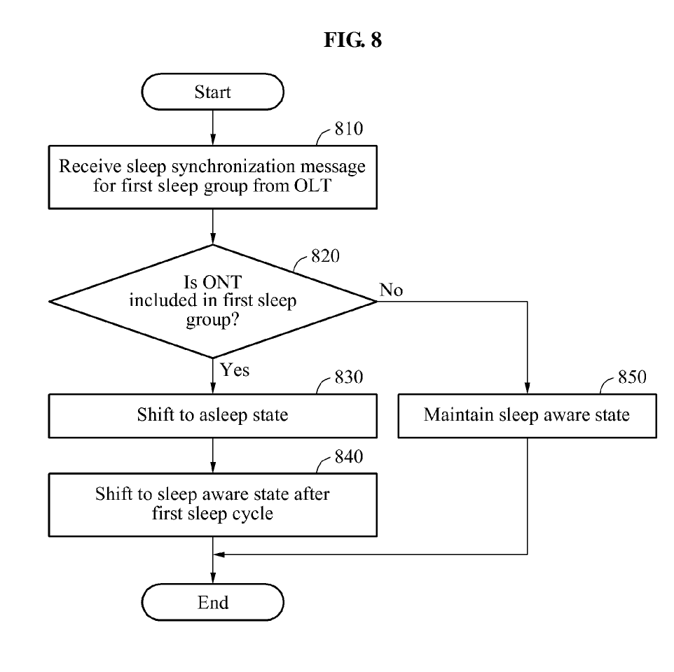

FIG. 8 is a flowchart illustrating a power saving method of an ONT according to an embodiment.

Referring to FIG. 8, in operation 810, the ONT may receive a sleep synchronization message for a first sleep group from an OLT. The OLT may transmit the sleep synchronization message for each sleep group using a multicast method, and may also transmit the same sleep synchronization message to the entire ONTs.

In operation 820, the ONT may determine whether the ONT is included in the first sleep group. When the OLT transmits the sleep synchronization message for each sleep group using the multicast method, operation 820 may be omitted and then operation 830 may be performed.

When the OLT transmits the same sleep synchronization message to the entire ONTs, an operation of determining whether a corresponding ONT is included in the first sleep group may need to be performed. In a case in which a state of the ONT is shifted in response to the sleep synchronization message for all the sleep groups, the power saving efficiency may be decreased.

In operation 830, when the ONT is included in the first sleep group, the ONT may shift to an asleep state in which an optical transmitter and an optical receiver are turned OFF. When the ONT is included in the first sleep group, sleep cycles of all the ONTs included in the first sleep group may be synchronized through the sleep synchronization message for the first sleep group. When the ONT shifts to the asleep state, a timer of a first sleep cycle may be set.

In operation 840, when the first sleep cycle of the first sleep group is elapsed, the ONT may shift to the sleep aware state in which the optical transmitter and the optical receiver are turned ON. Even in a synchronized sleep mode for power saving, the optical transmitter and the optical receiver may also need to be turned ON at predetermined intervals to receive a message for operating in a normal mode again.

In operation 850, when the ONT is not included in the first sleep group, the ONT may maintain the sleep aware state in which the optical transmitter and the optical receiver are turned ON. When the state of the ONT is shifted in response to the sleep synchronization message for all the sleep groups, the power saving efficiency may be decreased. Accordingly, a state of the ONT may not be shifted in response to a sleep synchronization message for another sleep group, not for the sleep group including the ONT.

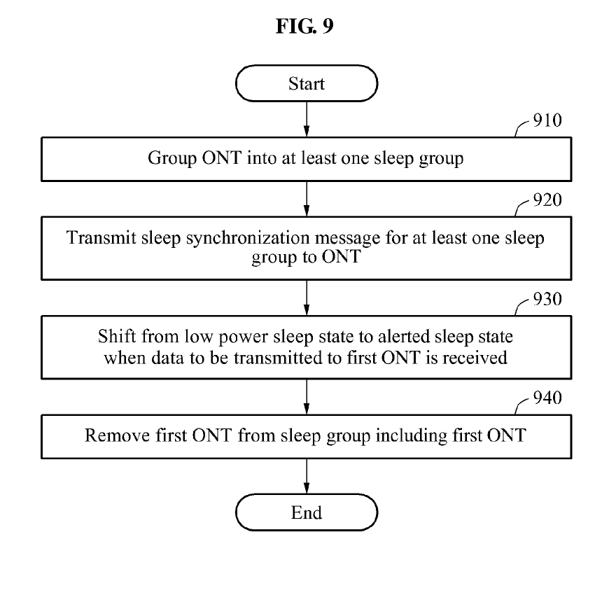

FIG. 9 is a flowchart illustrating a power saving method of an OLT according to an embodiment.

In operation 910, the OLT may group an ONT into at least one sleep group through signaling with the ONT. The OLT may perform grouping into consideration of a sleep cycle based on a type of a service being provided from the ONT and a hardware performance of the ONT.

In operation 920, the OLT may transmit a sleep synchronization message for at least one sleep group to the ONT. The OLT may transmit the sleep synchronization message for each sleep group at each sleep cycle of each sleep group, using a multicast method.

In operation 930, when data to be transmitted to a first ONT is received, the OLT may shift from a low power sleep state to an alerted sleep state. When the OLT shifts to the alerted sleep state, the OLT may transmit a low power state end message to the first ONT.

In operation 940, the OLT may remove the first ONT from a sleep group including the first ONT. Since the first ONT is removed from the sleep group, the sleep synchronization message may not be transmitted to the first ONT anymore.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple to types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few embodiments have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A power saving method of an optical network terminal, the method comprising:
receiving a sleep synchronization message about a first sleep group from an optical line terminal; and
shifting to an asleep state for turning OFF an optical transmitter when the optical network terminal is comprised in the first sleep group.

2. The method of claim 1, further comprising:
to shifting to a sleep aware state for turning ON the optical transmitter after a first sleep cycle of the first sleep group is elapsed.

3. The method of claim 2, wherein an optical receiver is further turned OFF in the asleep state, and the optical receiver is further turned ON in the sleep aware state.

4. The method of claim 1, further comprising:
maintaining a sleep aware state in which the optical transmitter is turned ON when the optical network terminal is not comprised in the first sleep group.

5. The method of claim 1, wherein the optical network terminal is grouped into one of at least one sleep group through signaling with the optical line terminal.

6. The method of claim 5, wherein a sleep cycle of each of the at least one sleep group is differently set.

7. The method of claim 6, wherein the sleep cycle of each of the at least one sleep group is differently set based on a type of a service provided from an optical network terminal comprised in each of the at least one sleep group and a hardware performance of the optical network terminal.

8. The method of claim 1, further comprising:
shifting from a sleep aware state to an active-held state for performing a normal operation when the optical network terminal receives a low power state end request message from the optical line terminal

9. The method of claim 8, wherein the shifting to the active-held state comprises transmitting a low power state switch end message to the optical line terminal when the optical network terminal shifts from the sleep aware state to the active-held state.

10. A power saving method of an optical line terminal, the method comprising:
grouping at least one optical network terminal into at least one sleep group; and
transmitting a sleep synchronization message about the at least one sleep group to the at least one optical network terminal.

11. The method of claim 10, wherein the grouping comprises differently setting a sleep cycle of each of the at least one sleep group.

12. The method of claim 11, wherein the differently setting comprises differently setting the sleep cycle of each of the at least one sleep group based on a type of a service provided from an optical network terminal comprised in each of the at least one sleep group and a hardware performance of the optical network terminal.

13. The method of claim 10, wherein the transmitting comprises transmitting the sleep synchronization message to an optical network terminal comprised in each of the at least one sleep group, at a sleep cycle corresponding to each of the at least one sleep group.

14. The method of claim 10, further comprising:
shifting from a low power sleep state to an alerted sleep state when data to be transmitted to a first optical network terminal is received; and
removing the first optical network terminal from a sleep group comprising the first optical network terminal.

15. The method of claim 14, wherein the shifting to the alerted sleep state comprises transmitting a low power state end request message to the first optical network terminal.

16. The method of claim 15, further comprising:
shifting from the alerted sleep state to an awake forced state for performing a normal operation in response to a low power state switch end message received from the first optical network terminal.

17. The method of claim 10, wherein the grouping comprises grouping the optical network terminal into one of at least one sleep group through signaling with the optical network terminal.

18. The method of claim 10, further comprising:
transmitting a low power state start request message to a second optical network terminal when traffic about the second optical network terminal is absent during a predetermined duration of time; and
shifting from an awake forced state for performing a normal operation to a low power sleep state for power saving.

19. The method of claim 18, wherein the shifting to the low power sleep state comprises adding the second optical network terminal to a sleep group determined to comprise the second optical network.

20. A power saving method of an optical network terminal, the method comprising:
receiving a sleep synchronization message about a predetermined first sleep group from an optical line terminal; and
determining whether to communicate with the optical line terminal, depending on whether the optical network terminal is comprised in the first sleep group.
